(19) United States
(12) Patent Application Publication
(10) Pub. No.: US 2020/0005411 A1
(43) Pub. Date: Jan. 2, 2020

(54) SYSTEM AND METHOD FOR CONVERTING INTELLECTUAL PROPERTY TO A MARKETABLE SECURITY

(71) Applicant: Marc R. Deschenaux, Geneva (CH)

(72) Inventor: Marc R. Deschenaux, Geneva (CH)

(21) Appl. No.: 16/457,471

(22) Filed: Jun. 28, 2019

Related U.S. Application Data
(60) Provisional application No. 62/691,500, filed on Jun. 28, 2018.

(51) Int. Cl. G06Q 50/18; G06Q 20/40; G06Q 40/04

(52) U.S. Cl. CPC G06Q 50/184; G06Q 40/04; G06Q 20/4016

(57) ABSTRACT

An apparatus, system, and method are disclosed for converting intellectual property to a marketable security, the system comprising an intellectual property owner; an intellectual property right, an issuer, an issue request, a method of agreement, an issued security, and a subscription.

### FIELD OF THE INVENTION

The present invention relates to the field of assets and financing and more specifically to the securitization of intellectual property rights.

### BACKGROUND

### Description of the Related Art

A security has been defined as converting (an asset, especially a loan) into a marketable security, typically for the purpose of raising cash by selling it to other investors. The process of securitization relies upon agreement (contract), indenture, or specific legal regulation, establishing, for instance, stocks and shares. A pass-through security has its origins in mortgage-backed securities.

Intellectual property rights are a legal mechanism to incentivize creation of intangible products. According to specific criteria, the creator is entitled to ownership of the work. Intellectual property consists of an intangible right, which is not held in the physical object, but in the legal construct. A patent protects a technical invention, which is novel and has a concrete use. A trademark is a sign, used in a business context, which is protected by an intellectual property right. A copyright gives the creator of an original work protection over their property.

The common law intellectual property system can be traced back to the “Statue of Ann” and the “1624 Statute of Monopolies”. Over time the rationale has changed from focusing on the labor of the individual to wider economic and social goals. Currently, creators or inventors lack an avenue for obtaining appropriate financing, based upon current and future revenue, in part because the absence of a reliable marketplace results in a difference between the actual and estimated value. Therefore, a need exists for creators to have an opportunity to finance their work that would beneficially increase incentive for innovation, optimize patterns of productivity, and discourage rent seeking.

### SUMMARY

From the foregoing discussion, it should be apparent that a need exists for a system and method that enable creators and innovators to finance their work. Beneficially, such a system and method would establish a reliable marketplace for intellectual property, increase incentive for innovation, optimize patterns of productivity and discourage rent seeking.

The innovation presented herein allows for the securitization of intellectual property and is in accordance with the rationale of the intellectual property system.

The ability to convert intellectual property rights into securities establishes a marketplace, which supports the rationale behind the intellectual property system itself. This resolves the situation caused by an absence of a reliable marketplace, which result in a difference between the actual and estimated value. The use of this invention allows the creator or inventor wider opportunity to develop and disseminate his work. The securitization is based upon the cash flow, which arises from ownership of the intellectual property. In the case of a pass-through security, based upon a mortgage, the right arises from the future payments, otherwise known as the debt, which has been accrued.

The present invention has been developed in response to the existing state of the art and in particular in response to the problems and needs in the art that have not yet been fully solved by currently available systems for financing intellectual property. Accordingly, the present invention has been developed to provide a system and method for intellectual property securitization that overcome many or all of the above-discussed shortcomings in the art.

Provided herein is system for converting an intellectual property right to a marketable security. In some embodiments the system comprises an intellectual property owner, an intellectual property right, an issuer, an issue request, a method of agreement, an issued security, and a subscription. In certain embodiments the method of agreement provides full or partial rights of intellectual property management to the issuer.

The system herein sometimes comprises at least one of an investor, an intellectual property manager, and a collection society. The issued security may comprise a pass-through security.

In various embodiments the pass-through security is traded on the NASDAQ or other exchange. The system may comprise a process for valuation of the intellectual property right, which process sometimes comprises a process for risk calculation. In some embodiments the system provided herein comprises software configured to automate the system.

Also provided herein is a method for converting an intellectual property right to a marketable security. The method in the disclosed embodiments substantially includes the steps necessary to carry out the functions presented above with respect to the operation of the described apparatus and system. In an embodiment the method comprises, creation or acquisition of an intellectual property right, a request for issuance, issuance of a security, creation of a subscription for the security, and vesting of ownership of the intellectual property right in the subscription. The security sometimes comprises a pass-through security.

The method herein may comprise valuation of the intellectual property right, which valuation of the intellectual property right may comprise calculating a risk. In certain embodiments the method herein comprises seeking an investor. In various embodiments the method comprises at least one of passing ownership to the investor and returning ownership to the original issuer. The method may comprises granting the issuer full or partial rights to manage the intellectual property. In some embodiments the method comprises employment of at least one of an intellectual property manager and a collection society. The method may comprise automating the method with software at any or all stages.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is an example of an embodiment of an intellectual property pass-through security in accordance with the present invention;

FIG. 2 is a schematic line drawing illustrating an embodiment of a system for converting intellectual property to a marketable security in accordance with the present invention; and

FIG. 3 is a schematic flow chart illustrating an embodiment of a method for converting intellectual property to a marketable security in accordance with the present invention.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, specific details are provided to provide a thorough understanding of embodiments of the invention. One skilled in the relevant art will recognize, however, that the invention may be practiced without one or more of the specific details, or with other methods, components, materials, and so forth. Well-known structures, materials, or operations are sometimes not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps show.

All illustrations of the drawings are for the purpose of describing selected versions of the present invention and are not intended to limit the scope of the present invention.

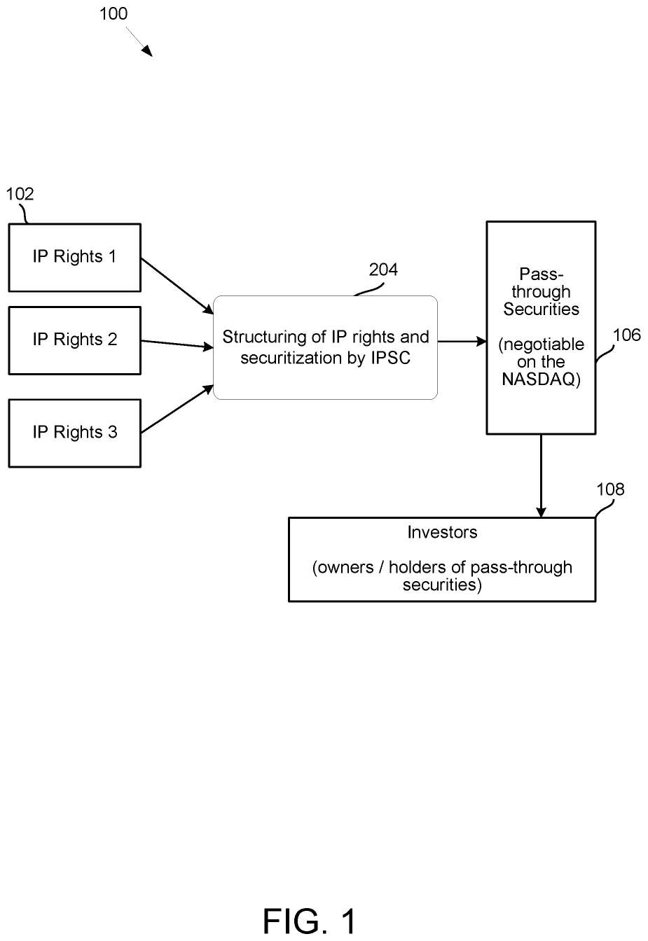

FIG. 1 an example of an embodiment of a pass-through system 100 for securitization of intellectual property rights comprising, for the sake of illustration IP rights 102 (here 1, 2, and 3) in a single project. These rights are consolidated in the structuring of the IP rights securitization 104 to create a pass-through security 106 negotiable on a stock exchange such as the NASDAQ. Investors 108 become the holders of the pass-through security 108.

In certain embodiments the pass-through system 100 is configured for direct ownership by multiple investors. Use of the pass-through system 100 may establish a marketplace for intellectual property securities and provide for brokerage on the public of private market and thus facilitate the raising of capital by owners of intellectual property.

Candidates for this service include without limitation innovators and inventors in all fields, major production companies, publishing houses, record companies and auction houses. Currently the provision of financing is often accompanied by a restriction on the content and execution of the work. Therefore, the system and method provided herein may facilitate wider freedom in the production of technology, culture, science and the arts by enabling the value of an intellectual property to be converted into a form of greater liquidity that enables faster, more transparent investment.

In certain embodiments owners of an intellectual property right can obtain funding for a work in various stages of completion. Some embodiments provide a means for investors to invest in a specific intellectual property securitization, as opposed to a pooled group of securities. In various embodiments the created security is based on an Intellectual Property right and not primarily on debt or equity.

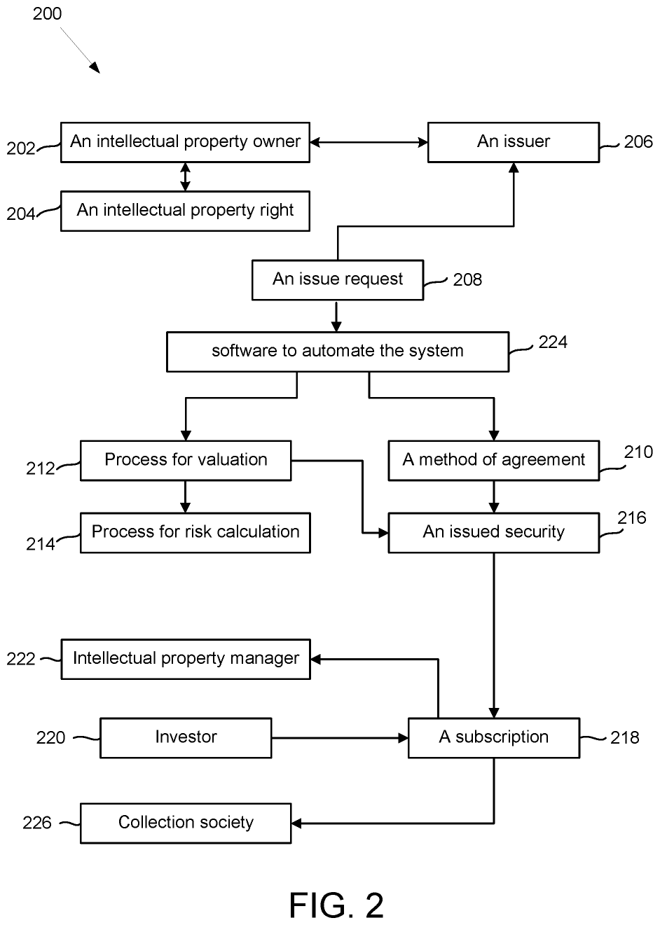

FIG. 2 is a schematic line drawing illustrating an embodiment of the system 200 presented herein to enable an intellectual property owner 202 to create a subscription 218 for the right to invest, the system 200 comprising an intellectual property owner 202, an intellectual property right 204, an issuer 206, an issue request 208, a method of agreement 210, a process for valuation 212, a process for risk calculation 214, an issued security 216, a subscription 218, an investor 220, an intellectual property manager 222, and a collection society 224.

In some embodiments the intellectual property owner 202 and the issuer 206 are the same entity. IPSC directly converts IP rights into securities. However, as it is a pass-through security, the investors acquire the property of the securities rather than a claim on the proceeds of the securities. IPSC pools the IP rights and securitizes them but does not operate as a special purpose vehicle and does not issue asset-backed bonds. Rather, investors directly hold the securities issued by IPSC. In some embodiments IPSC does not pool IP rights arising or in connection with various projects in one issuance, but rather IP right arising or in connection with a single project in one issuance.

The method of agreement 210 may be initialized with a request for issuance of the security made by the owner 202 of the intellectual property right 204. The system 200 sometimes includes a process for valuation 212. In certain embodiments the status, quality and profitability of the intellectual property right 204 are analyzed according to market value. A process for risk calculation 214 may be included in the process for valuation 212. The issued security 216 becomes the basis for the subscription 218, which is then available to the investor 220. The intellectual property owner 202 and/or the issuer 204 may engage an intellectual property manager 222 and a collection society 224 may collect and disperse subscription fees.

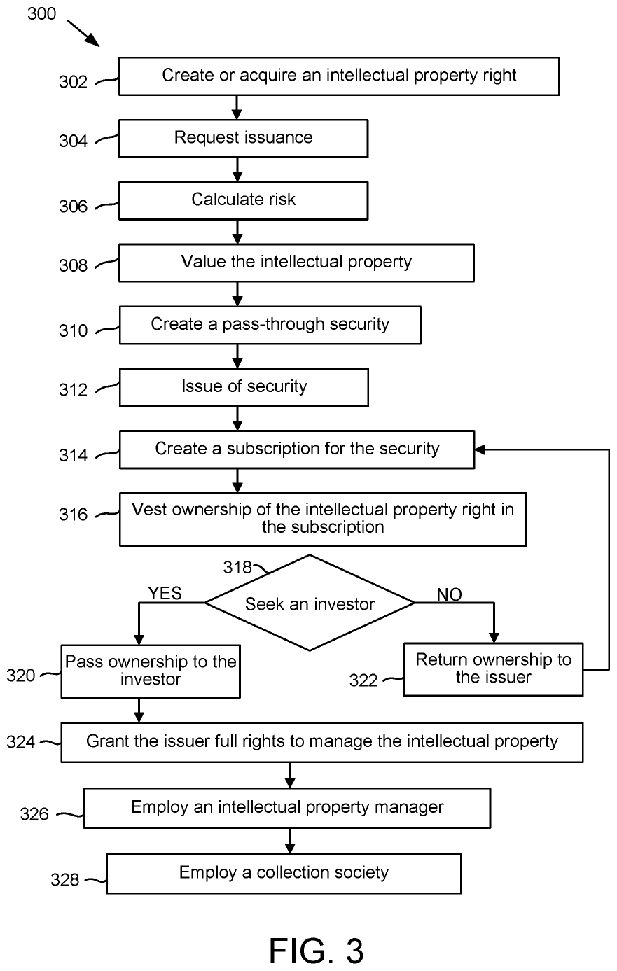

FIG. 3 is a schematic flow chart diagram illustrating an embodiment of a method 300 for conversion of an intellectual property right to a marketable security. The method 300 comprises the steps: creation or acquisition of an intellectual property right 302, request for issuance 304, calculation of risk 306, valuation 308, creation of a pass-through security 310, issuance of a security 312, creation of a subscription for the security 314, vesting of ownership of the intellectual property right in the subscription 316, query 318 for investors, if NO return of ownership to the original owner 320, if YES passing ownership to the investor 322, granting full rights of intellectual property management to the issuer 324.

In some embodiments use of a pass-through security allows ownership to be held directly by the investor 220. In such cases a trustee body is not the holder of the security right. The issuer 206 may retain right to management of intellectual property, or may be granted a license, whilst a collection society 224 may be used to collect the revenue. Software may be used to automate the method at any or all stages.

In certain embodiments of the present method the issuance of the security 216 takes place when there is not yet party to the agreement, in which case ownership of the intellectual property right 204 is vested in the subscription 218. Should the project fail to attract an investor 220, the right will return to the initial owner 202. In some embodiments the security product is not pooled together with other similar security products, but the intellectual property is offered on a particular basic, so the investment is in a specific item, which is clearly identifiable.

In various embodiments the specific system of securitization enables trades to take place on the NASDAQ. Therefore, a holder may exit at the stage of brokerage through a public or private offering.

The system and method presented herein provide the means for individuals to invest and for an individual issuer or a collective issuer to raise capital originating from multiple investors. For example:

A director decides to use securitization to raise funds for a future movie, which has not yet been filmed. After a request is made:
1. The valuation process estimates, based upon the monetary success of his previous films and the size of the audience, that it will have a market value of 200 million.
2. The cost to film, produce and distribute the movie is a fraction of this value, thus the project is viable.
3. The director owns the intellectual property, whilst having a profit share agreement, with a distribution company.
4. After issuance of the security, the intellectual property right is securitized.
5. A Platform is set up, whereby investors can invest in this movie, thus gaining direct ownership in the intellectual property.
6. Marketing of the opportunity allows a fan base to invest in this movie.
7. The intellectual property is not pooled with similar products but is offered on an individual basis. The investor is investing in a movie, not a pooled group of movies.
8. A license is granted to the director, giving him the right to manage the intellectual property.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for converting an intellectual property right to a marketable security, the system comprising:
an intellectual property owner;
an intellectual property right;
an issuer;
an issue request;
a method of agreement;
an issued security; and
a subscription.

2. The system of claim 1, wherein the method of agreement provides full rights of intellectual property management to the issuer.

3. The system of claim 1, further comprising at least one of an investor, an intellectual property manager, and a collection society.

4. The system of claim 1, wherein the issued security comprises a pass-through security.

5. The system of claim 4, wherein the pass-through security is traded on the NASDAQ or other exchange.

6. The system of claim 1, further comprising a process for valuation of the intellectual property right.

7. The system of claim 6, wherein the process for valuation of the intellectual property right comprises a process for risk calculation.

8. The system of claim 1, further comprising software to automate the system.

9. A method for converting an intellectual property right to a marketable security, the method comprising:
creation or acquisition of an intellectual property right;
a request for issuance;
issuance of a security;
creation of a subscription for the security; and
vesting of ownership of the intellectual property right in the subscription.

10. The method of claim 9, wherein the security comprises a pass-through security.

11. The method of claim 9, further comprising valuation of the intellectual property right.

12. The method of claim 11, wherein valuation of the intellectual property right further comprises calculating a risk.

13. The method of claim 9, further comprising seeking an investor.

14. The method of claim 9, further comprising at least one of passing ownership to the investor and returning ownership to the original issuer.

15. The method of claim 9, further comprising granting the issuer full rights to manage the intellectual property.

16. The method of claim 9, further comprising employment of at least one of an intellectual property manager and a collection society.

17. The method of claim 9, further comprising automating the method with software at any or all stages.
